(19) United States
(12) Patent Application Publication
(10) Pub. No.: US 2003/0074939 A1
(43) Pub. Date: Apr. 24, 2003

(54) Key and associated lock cylinder

(76) Inventor: Peter Braun, Bornheim (DE)

Correspondence Address: Richard J Veltman, Black & Decker Corporation, 701 E Joppa Road, TW 199, Towson, MD, 21286, US

(21) Appl. No.: 10/181,303

(22) PCT Filed: Nov. 23, 2001
(86) PCT No.: PCT/EP01/13727

(30) Foreign Application Priority Data
Nov. 25, 2000 (DE) 10058590.6

(51) Int. Cl. E05B 19/06; E05B 27/04

(52) U.S. Cl. 70/409; 70/493

(57) ABSTRACT

A lock cylinder with a cylinder core rotably mounted in a housing and normally locked against rotation by means of pin tumblers comprising core and housing pins mounted in core and housing orifices, spring-loaded against the housing and displaceable into a release position by insertion of a key (2) into a lock channel, wherein the cylidner core has at least one support pin inserted in a radial orifice of the cylinder core and spatially associated with a pin tumbler in such a way that the pin tumbler can be located between the support pin and core pin by interposition of a spacer (9) movably associated with the key (2), wherein the radial bore bearing the support pin extends obliquely to the orifice bearing the core pin, and the direction of movement of the spacer (9) extends obliquely to the broadside face of the key (2).

The invention relates initially to a key for a lock cylinder with a bit comprising lock recesses cooperating with the core pins of the lock cylinder, in which bit a spacer is movably mounted.

A key of this type is already known from EP 0 029 498. The spacer there is designed as a sphere.

The invention also relates to a lock cylinder with a cylinder core rotatably mounted in a housing and normally locked against rotation by means of pin tumblers comprising core and housing pins mounted in core and housing orifices, spring-loaded against the housing and displaceable into a release position by insertion of a key into a lock channel, wherein the cylinder core has at least one support pin inserted in a radial orifice of the cylinder core and spatially associated with a pin tumbler in such a way that the pin tumbler can be located between the support pin and core pin by interposition of a spacer movably associated with the key.

The object of the invention is to expediently develop a generic key and a generic lock cylinder. The object is achieved by the invention recited in the claims.

Claim 1 initially and substantially proposes that the direction of movement of the spacer extends obliquely to the key broadside face. Claim 8 relating to the lock cylinder proposes that the radial orifice bearing the support pin extends transverse to the orifice bearing the core pin.

As a result of this design, not only is the variety increased but there is also the possibility of manufacturing by one and the same manufacturing concept, lock cylinders and keys in which the key channel width extension extends transverse to the alignment direction of the tumbler pin orifices as well as those in which the width extension of the key channel extends parallel to the line of alignment of the tumbler pin orifices. In a further development of the invention it is proposed that the support pin orifice is offset by about 45° outside the line of alignment to the core pin orifice. It is located in the cross-sectional plane through the cylinder core. The movement direction of the spacer is accordingly tilted at an angle of approximately 45° to the key broadside in the case of the key. This angular position is advantageous if the long side of the substantially rectangular key channel extends both transverse to the alignment direction of the pin orifices and also parallel to the alignment direction of the pin orifices.

In a further development of the invention it is proposed that the spacer is a ring arranged in an oblique slot in the bit and traversed by a journal with play. With this design it may be advantageous if the peripheral face of the ring forms two 45° chamfers which intersect or almost intersect and form an angle of 90°. One of the two chamfers can then cooperate with a cone envelope of the tip of the support pin and the other chamfer can cooperate with the truncated cone face of the core pin. This can also be reversed. It is also advantageous if the key combination is varied in that the ring has various diameters. Supplementary tumbler pins can also be provided in the lock cylinder. In known manner, these can cooperate with a blocking needle which is movable in a parting face between the cylinder core and the inside wall of the cylinder core orifice in such a way that it can adopt a blocking position and a release position in a known manner.

Embodiments of the invention are described hereinafter with the aid of the attached drawings, in which:

FIG. 1 shows a first embodiment of a key according to the invention,

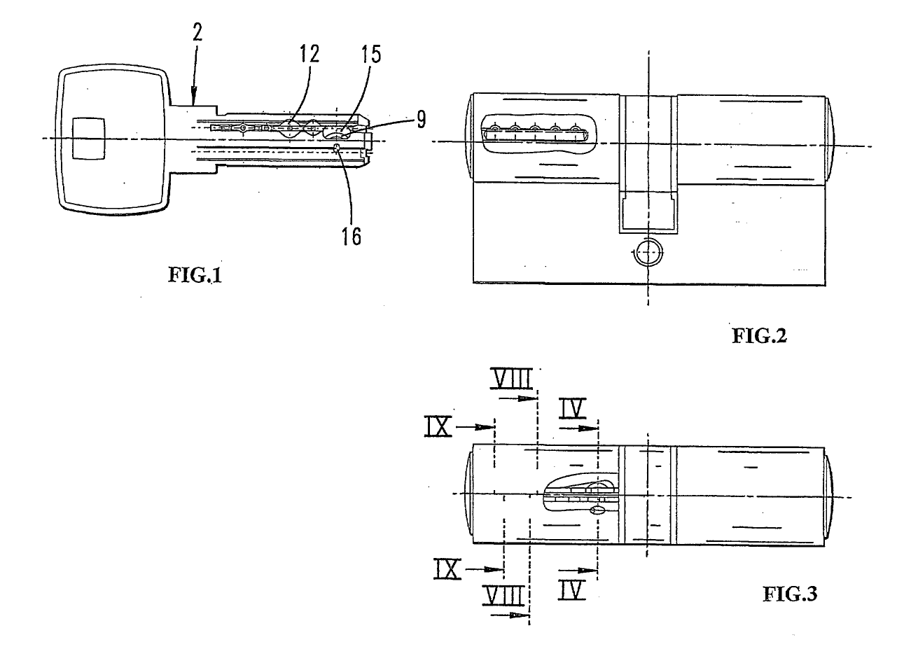

FIG. 2 is a broadside view of a lock cylinder,

FIG. 3 is a plan view of a lock cylinder,

FIG. 4 is a section according to section line IV-IV in the lock cylinder according to FIG. 2 or 3,

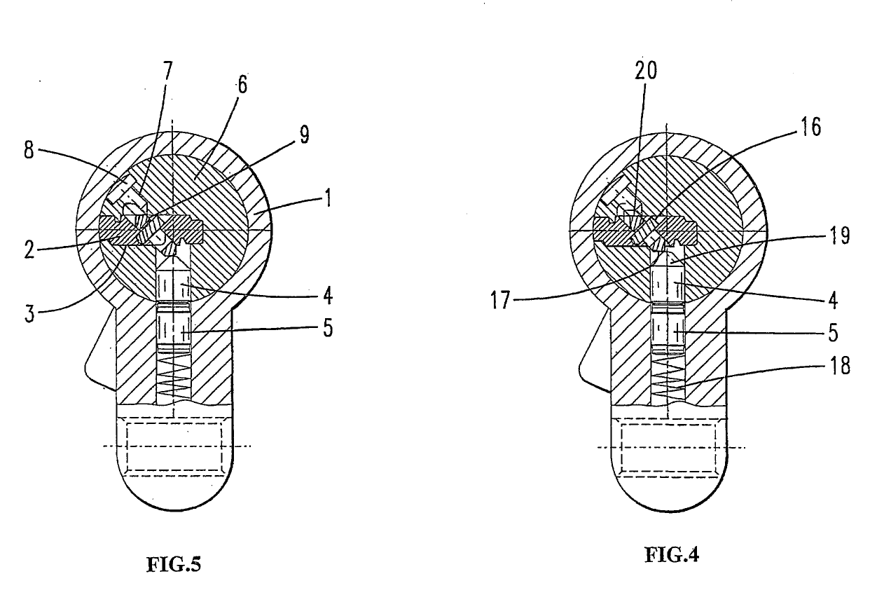

FIG. 5 is a section according to FIG. 4 with a shorter core pin and ring with larger diameter,

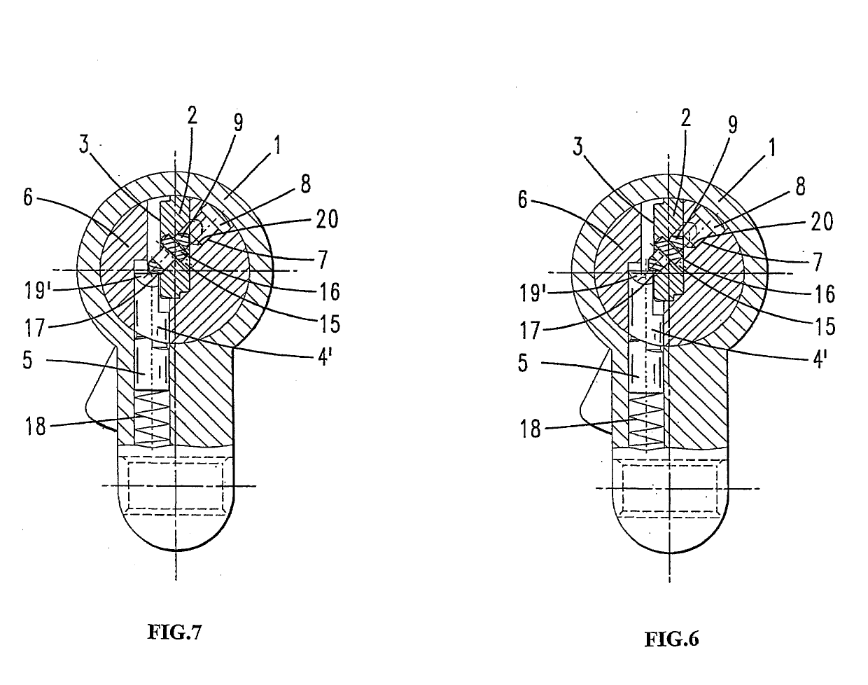

FIG. 6 is a section according to FIG. 4 with a lock cylinder of a further embodiment in which the width extension of the lock cylinder extends parallel to the axis of the tumbler pins,

FIG. 7 is a view according to FIG. 6, but with shorter core pin and a spacer with a larger diameter,

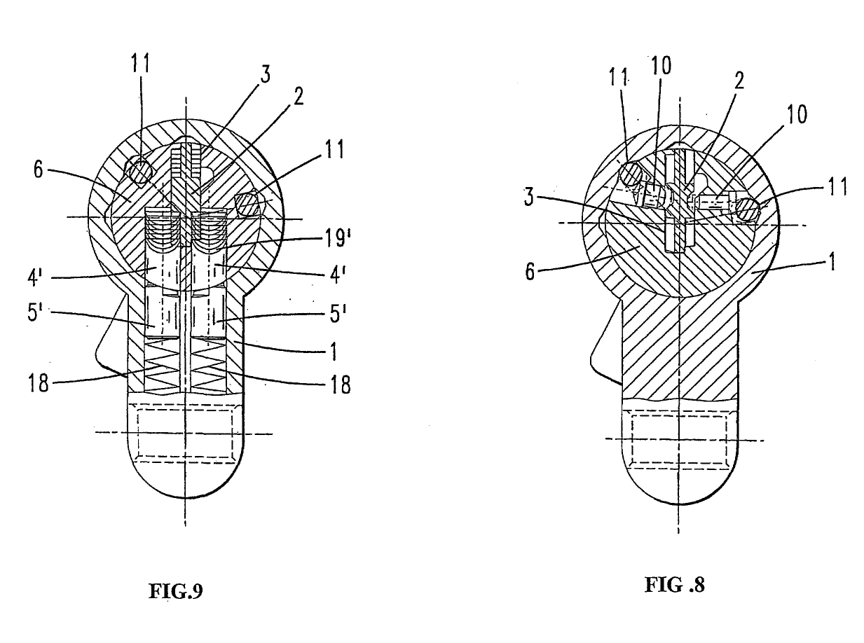

FIG. 8 is a section according to the line VIII-VIII in FIG. 3,

FIG. 9 is a section according to the line IX-IX in FIG. 3,

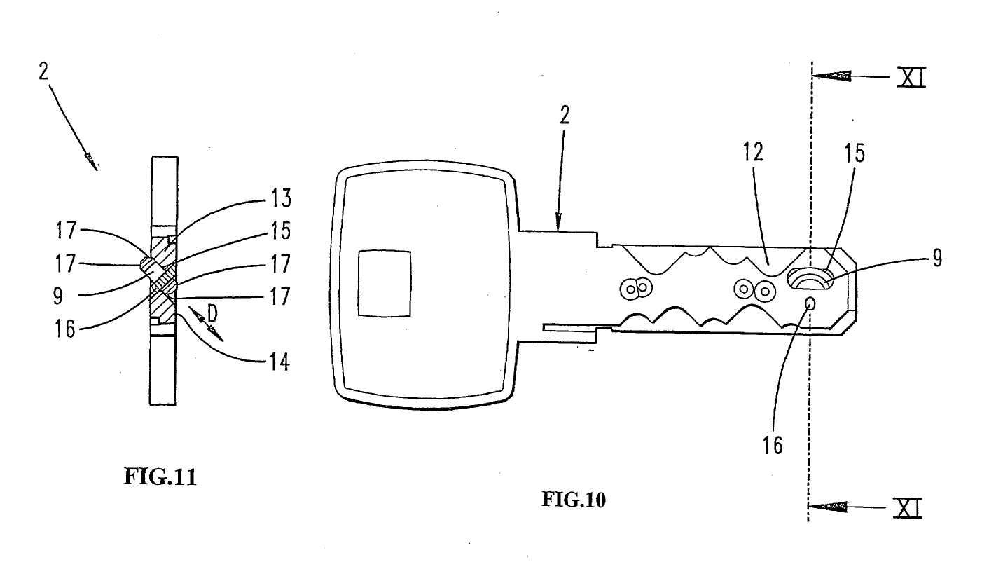

FIG. 10 is a plan view of a key of a second embodiment,

FIG. 11 is a section according to the line XI-XI in FIG. 10.

The flat key shown in FIG. 1 is a turnkey and, on its broadside face, has a profiling in the form of a plurality of lock recesses 12 which cooperate with the truncated cone tips 19 of core pins 4. The key also has an oblique slot 15 in the region of its tip. In this oblique slot 15 is located a ring in the form of an annular disc 9 through the opening of which a journal 16 projects which binds the ring 9 in the oblique slot. As the diameter of the journal 16 is smaller than the recess diameter of the ring 9, the ring 9 can move with play in the oblique slot 15 in an oblique direction to the broadside plane of the bit.

FIGS. 4 and 5 show a section with key inserted. The section is through the ring 9. The ring has two chamfers 17 on its outer wall in each case, which adopt an angle of 90° to one another. One of the two chamfers 17 rests on the truncated cone face of the tip 19 of the core pin 4. The core pin is supported in known manner by a housing pin 5 which is spring-loaded against the base of a pin orifice by a spring 18. The cylinder core 6 located in a core orifice of the housing 1 has a radial orifice 7 oblique to the pin tumbler orifice. There is a support pin 8 in this radial orifice 7. The support pin 8 has a cone tip 20. The chamfer 17 of the ring 9 which is transversely displaceable to the axis of the pin tumbler 4, 5, rests on the envelope of the tip in this process. This results in the ring 9 having a distancing effect on the core pin 4. As seen in particular from FIGS. 4 and 5, the ring 9 projects in portions into the pin orifice of the core pin in certain regions.

A variation in the key profile can be achieved by using rings 9 with different diameters. The axial length of the core pin 4 has to be adapted accordingly thereto.

While the key channel 3 has a transverse extension to the axis of the core pin 4 in the embodiments shown in FIG. 4 and 5, the embodiments shown in FIG. 6 and 7 have a key channel 3 whose broadside extension is parallel to the core pin axis. The core pins 4′ there have roof-shaped tips 19′.

In this embodiment, the core pins 4 and the housing pins 5 are laterally offset with respect to the central plane of the cylinder housing.

In the embodiments according to FIG. 4 to 7, the displacement direction of the spacer 9 extends parallel to the axial direction of the radial orifice 7 in which the support pin 8 is located.

The embodiment shown in FIG. 9 has pin tumblers 4′, 5′ arranged in two rows outside the longitudinal central plane. The tips 19′ of the core pins are roof-shaped. The key 2 accordingly has a structure consisting of three discs. The central disc forms a core web. The two outer discs have lock recesses 12 in the form of notches. This is shown in FIG. 10 and 11.

It emerges from FIG. 11 that the direction of movement D of the ring 9 adopts a 45° angle to the broad face 4 of the bit.

The lock cylinder has supplementary pins 10 in known manner, which are not spring-loaded. The supplementary pins 10 cooperate in known manner with a blocking needle 11 which can enter a blocking position in the parting plane of the cylinder core and cylinder core housing orifice. Only when the supplementary tumbler pin 10 enters a recess associated with it of the key broadside, can the blocking needle be displaced from a blocking position into the release position.

It is advantageous that the journal 16 which holds the ring 9 in the oblique slot 15 is inserted in an orifice produced obliquely into the key broadside. This can be a blind orifice. Simple assembly of the ring is possible. The ring can also be provided with a ring with another diameter by either knocking out the journal or drilling it out, so the key combination can be changed.

All disclosed features are (per se) essential to the invention. The disclosure of the associated/attached priority documents (copy of the previous application) are also fully included herewith in the disclosure of the application, also with the purpose of incorporating features of these documents into the claims of the present application.

1. Key for a lock cylinder with a bit (13) comprising lock recesses (12) cooperating with the core pins (4, 4′) of the lock cylinder in which bit a spacer (9) is movably mounted, characterised in that the direction of movement (D) of the spacer (9) extends obliquely to the broadside face (14) of the key.

2. Key according to claim 1 or in particular according thereto, characterised in that the movement of direction (D) is inclined by an angle of approximately 45° to the broadside face (14) of the key.

3. Key according to one or more of the preceding claims or, in particular according thereto, characterised in that the spacer (9) is a ring (9) arranged in an oblique slot (15) of the bit (13), which ring is traversed with play, by a journal (16).

4. Key according to one or more of the preceding claims or, in particular according thereto, characterised in that the journal (16) is inserted in an oblique orifice of the broadside face of the key.

5. Key according to one or more of the preceding claims or in particular according thereto, characterised in that the peripheral face of the ring (9) forms two 45° chamfers (17).

6. Lock cylinder with key according to one or more of the preceding claims or in particular according thereto, characterised in that one of the chamfers (17) cooperates with a cone envelope of the tip of the supporting pin (8) and the other chamfer (17) cooperates with the truncated cone face of the core pin (4) or vice versa.

7. Lock cylinder with a cylinder core rotatably mounted in a housing (1) and normally locked against rotation by means of pin tumblers comprising core and housing pins (4, 5) mounted in core and housing orifices, spring-loaded against the housing and displaceable into a release position by insertion of a key into a lock channel, wherein the cylinder core (6) has at least one support pin (8) inserted in a radial orifice (7) of the cylinder core (6) and spatially associated with a pin tumbler (4′, 5′) in such a way that the pin tumbler (4′, 5′) can be located between the support pin (8) and core pin (4) by interposition of a spacer (9) movably associated with the key, characterised in that the radial bore (7) bearing the support pin (8) extends obliquely to the orifice bearing the core pin (4).

8. Lock cylinder according to claim 8 or in particular according thereto, characterised in that the support pin orifice (7) is offset by about 45° outside the line of alignment to the core pin orifice.

9. Lock cylinder according to one or more of the preceding claims or in particular according thereto, characterised in that the long side of the substantially rectangular key channel (3) extends transverse to the direction of alignment with the core pin orifice.

10. Lock cylinder according to one or more of the preceding claims or in particular according thereto, characterised in that the long side of the substantially rectangular key channel (3) extends parallel to the direction of alignment with the core pin orifice.

11. Lock cylinder according to one or more of the preceding claims or in particular according thereto, characterised by supplementary tumbler pins which cooperate with lock recesses in the key broadside.

12. Lock cylinder according to one or more of the preceding claims or in particular according thereto, characterised by a blocking needle (11) cooperating with one or more of supplementary tumbler pins and arranged in the region of the parting plane between the cylinder core envelope and the housing orifice internal face.

13. Lock cylinder with key according to one or more of the preceding claims or in particular according thereto, characterised by a variation of the key combination by rings (9) of different diameter.
